(19) United States
(12) Patent Application Publication
(10) Pub. No.: US 2004/0064371 A1
(43) Pub. Date: Apr. 1, 2004

(54) On-line registration system and method

(76) Inventor: Jeff D. Crapo, Cedar Hills, UT (US)

Correspondence Address: Vanessa B. Pierce, Parsons Behle & Latimer, One Utah Center, 201 South Main Street, Suite 1800, Salt Lake City, UT, 84111-2218, US

(21) Appl. No.: 10/674,746

(22) Filed: Sep. 30, 2003

Related U.S. Application Data
(63) Continuation of application No. 09/645,077, filed on Aug. 23, 2000, now abandoned.
(60) Provisional application No. 60/150,461, filed on Aug. 23, 1999.
(60) Provisional application No. 60/150,237, filed on Aug. 23, 1999.

(51) Int. Cl. G06F 17/60

(52) U.S. Cl. 705/14

(57) ABSTRACT

The present invention is a unique system and method for registering potential members for an incentive awards-based system and method that provides generic miles for a variety of behaviors that are redeemable for tickets for world-wide travel on any airline. The system determines whether the individual actively contacted the system. If the individual was identified without active participation by the individual, a passive registration process is used to proactively identify and contact the prospective member and entice him or her with generic miles incentive to register for the system. The prospective member then can accept the invitation to register without much effort on the part of the prospective member. If the individual actively contacted the system to register with the system, the active registration process is initiated to allow a prospective member to register with the system in order to receive generic miles incentives.

### CROSS-REFERENCE TO RELATED APPLICATION

This application claims the benefit under 35 U.S.C. § 119(e) to both Jeff Crapo, U.S. provisional patent application serial No. 60/150,461 entitled “On-Line Passive Registration System and Method,” filed on Aug. 23, 1999 and Jeff Crapo, U.S. provisional patent application serial No. 60/150,237 entitled “On-Line Active Registration System and Method,” filed on Aug. 23, 1999, both of which are incorporated by reference in their entirety herein.

### BACKGROUND OF THE INVENTION

1. Field of the Invention

This invention relates generally to systems and methods for promoting customer loyalty and rewarding behaviors. More specifically, the present invention relates to the registration of customers for a loyalty incentive program.

2. Description of the Background Art

With the Internet becoming the fastest adopted technology in history, businesses and home users worldwide are connecting to the Internet, thereby creating a truly global marketplace. Internet commerce also has become rapidly accepted as a highly efficient method of conducting business between merchants and consumers. Consumers specifically are attracted to the Internet because of its simplicity, speed, convenience and unlimited magnitude.

These very attributes, however, are beginning to generate a backlash with on-line merchants. For example, with just a few clicks, consumers can pit on-line merchant rivals against each other in a virtual price war. On-line merchants, therefore, are seeking better competitive advantages in order to defend their business as the Internet becomes a more ruthlessly efficient marketplace. As the world shifts its focus to Internet commerce, on-line merchants of every size specifically are seeking new and effective ways to attract and retain customers in the wake of this increasing on-line competition.

An additional pressure upon on-line merchants is that as Metcalf's Law states the value of an on-line system is dependent upon the square of the number of users of that system. Examples of the importance of obtaining and maintaining enough users to ensure that one's product or service becomes an accepted standard include the telephone, the facsimile machine and Internet protocols. Once such a standard has achieved critical mass with the number of individuals using the product or service, the value of that product or service multiplies exponentially. In the online merchant paradigm, with regard to dealing with first-time customers, even once that customer is attracted to a certain brand or on-line system, if there are no incentives for the customer to return for future services or products, customers easily can be lured away by promotions or marketing campaigns to competing products or services. One attempted solution to this lack of customer loyalty with regard to the Internet has been to attempt to create an on-line equivalent of an exclusive Manhattan address, which is intended to convince consumers not to shop with the competition. Unfortunately, such a conventional technique does not effectively work because in the on-line environment, a customer easily can contact another merchant, who is providing similar goods or services, without much effort.

An alternative attempt to address the customer loyalty issue is to rely upon a loyalty incentive program. Loyalty programs were created from the realization that it was possible to change customer behavior patterns to such a degree that new customers would behave like established customers. Such loyalty programs are much more effective than promotions or discounts because loyalty programs add value to the brand and reward loyal customers by continuing to increase the level of added value each time the customer returns. There are a variety of incentive and loyalty programs that have been developed and continue in existence today. For example, incentive programs include rebates, discounts and coupons where incentives are offered in the short term to motivate a particular purchase. In contrast, loyalty programs attempt to develop loyalty to a particular product or service over a longer term. Most loyalty programs are based on a premise that if you perform a specific behavior (most often purchasing goods or services from a particular source), then you are awarded some unit that when accumulated may be redeemed for various goods. For example, frequent flyer mileage award programs administered by airlines are well known. These frequent flyer mileage award programs include a frequent flyer member and an airline as shown in FIG. 1A. miles are awarded by the airline for each segment traveled on the airline. Miles are awarded based on the distance traveled on various flights. These frequent flyer mileage award programs also sometimes allow awarding of mileage purchased by third parties from the airlines. Miles are awarded and accumulated by the member. Once the member has accumulated sufficient miles, the member may redeem the miles in exchange for a ticket for travel on the airline.

Variations on theses frequent flyer programs also have been developed such that if a user of a credit card from a particular bank can also earn frequent flyer miles. An exemplary conventional system for such a loyalty program is shown in FIG. 1B. The conventional system includes a member, a bank or company and an airline. The member is awarded miles based on usage of the member's credit card. A typical scenario is that the member of the system is awarded one mile for each dollar spent. Miles are awarded by the bank and accumulated by the member. Once the member has accumulated a sufficient number of miles, the member may redeem the miles with the bank, and the bank purchases a ticket from the airline. The airline delivers the member this free airline ticket to the destination of the member's choice, which the airline services.

Unfortunately, there are a number of problems with such a conventional loyalty program. First, the attractiveness of the loyalty incentive is significantly diminished once the user learns of all of the restrictions and lack of seat availability for the free ticket that is awarded under many frequent flyer award programs. Most of all, existing airline frequent flyer award programs impose restrictions on the number of seats available for each flight, the times when the tickets for free travel can be used, the class of travel for which the ticket can be used, and the geographic areas to which the user can travel. As the number of participants in such programs has increased, the seat restrictions on such programs has made them ineffective as an incentive since there are few, if any, times during peak travel time when the user can use awarded tickets. Furthermore, the complicated rules for usage and award make existing programs even less attractive. Therefore, there is a need for a generic mileage loyalty program that is not subject to the restrictions of the conventional art.

In addition, the incentives are inherently limited because the awarded tickets only are valid for the particular airline with which the bank is affiliated. This limitation on the incentive is a restriction in two ways. First, the awarded ticket only may be used for a particular airline. Secondly, since no airline flies to every location in the world, the destinations to which the user can travel with the awarded ticket are limited to the destinations in the carrier's routing system. For smaller airlines, this presents a particular problem. More generally, this type of incentive limits the value of the awards because much international travel, in particular to exotic locations, are not possible. Basically, this forces the user to a choice of traveling on one or a limited number of airlines. Therefore, there is a need for a generic mileage loyalty program that does not restrict travel to a single or select airlines and that allows redemption of mileage for travel on any airline.

Yet another shortcoming of the conventional art is that incentive value of the rewards (free tickets) is diminished by their difficulty to earn them. More specifically, the traditional systems and methods provide very limited ways to earn miles such as: 1) by travel on the airline or 2) by purchase using the credit card of the bank. Therefore, it is very difficult, and takes a considerable amount of time to earn a free ticket for travel. Thus, there is a need for a system and method that allows for the earning of miles through a variety of different behaviors.

In addition to the problem of building customer loyalty, the merchant also confronts the further problem of identifying customers who would exhibit such loyalty tendencies. In fact, identifying such customers is an expensive activity in the span of a normal company-client relationship. Most merchants have attempted to address this problem by using traditional mass marketing techniques for capturing such customers. In this manner, a merchant allocates as much as 70 percent of its capital to reach such customers. Unfortunately, such a technique is quite expensive and does not efficiently target specific customers, who would be interested in the merchant's goods or services and who would remain loyal based upon an incentive program.

Therefore, there is a need for an improved system and method for identifying customers, who would be interested in receiving generic miles for a variety of behaviors that are redeemable for tickets for world-wide travel on any airline.

### SUMMARY OF THE INVENTION

The present invention overcomes the deficiencies and limitations of the conventional art with a unique system and method for identifying potential members for an incentive awards based system and method that provides generic miles for a variety of behaviors that are redeemable for tickets for world-wide travel on any airline.

The system preferably comprises: a web server, an application server, a database sever and a disk array. The application server further includes a registration unit, which is operable on the application server to provide registration services. In particular, the registration unit first determines whether the individual actively contacted the system. If the individual was identified without active participation by the individual, a passive registration process is used to proactively identify and contact the prospective member and entice him or her with generic miles incentive to register for the system. The prospective member can efficiently accept the invitation to register without much effort on the part of the prospective member. If the individual actively contacted the system to register with the system, the active registration process allows a prospective member to efficiently register with the system in order to receive generic miles incentives.

These and other features and advantages of the present invention may be better understood by considering the following detailed description of preferred embodiments of the invention. In the course of this description, reference will frequently be made to the attached drawings.

### BRIEF DESCRIPTION OF THE DRAWINGS

The accompanying drawings, that are incorporated in and constitute a part of this specification, illustrate several embodiments of the present invention and, together with the written description, serve to explain the principles of the present invention.

FIG. 1A is a diagram of a first conventional mileage loyalty award program.

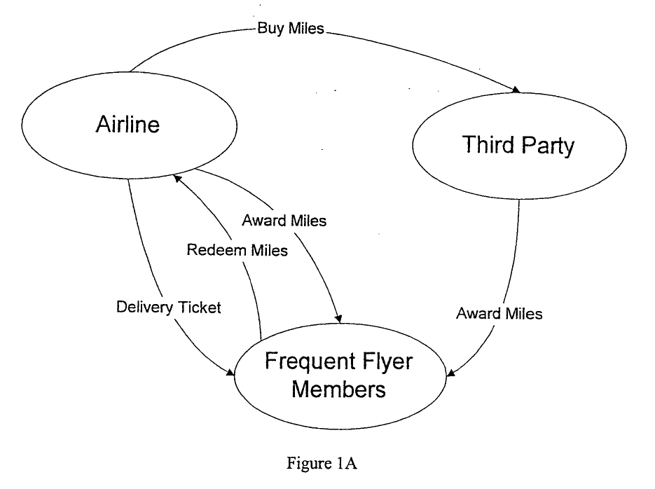

FIG. 1B is a diagram of a second conventional mileage loyalty award program.

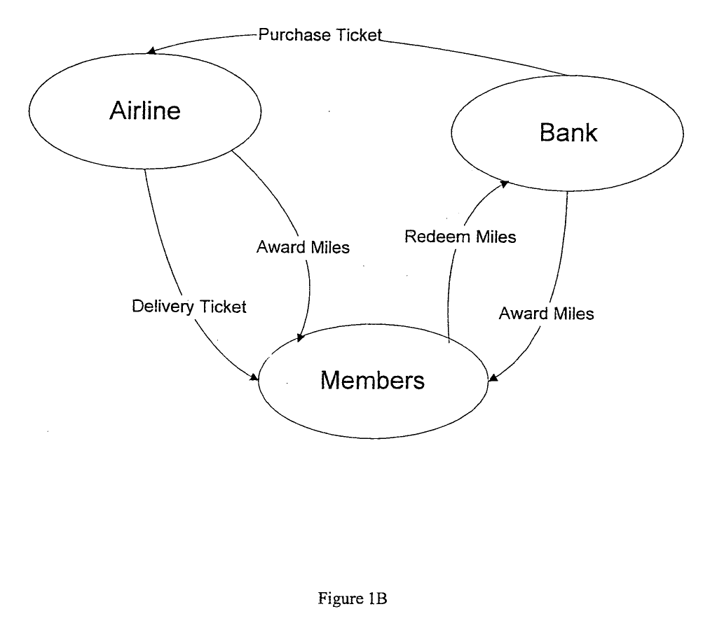

FIG. 2A is a diagram of a first and preferred embodiment of a global generic mileage loyalty incentive system according to the present invention.

FIG. 2B is a diagram of a second embodiment of a global generic mileage loyalty incentive system according to the present invention.

FIG. 3 is a high-level block diagram of the system of the present invention coupled to other systems via the Internet.

FIG. 4A is a block diagram of a preferred embodiment of the system of the present invention coupled to the Internet.

FIG. 4B is a block diagram of a second embodiment of the system of the present invention coupled to the Internet.

FIG. 5A is a block diagram of a preferred embodiment for the memory of the Application Server of the present invention.

FIG. 5B is a block diagram of a preferred embodiment for the memory of the application sever of the present invention.

FIG. 6 is a flowchart of a preferred method for the operation of a registration method of the present invention in accordance with a preferred embodiment of the present invention.

FIG. 7 is a flowchart of a preferred method for the operation of a passive registration method in accordance with a preferred embodiment of the present invention.

FIG. 8 is a flowchart of a preferred method for the operation of an active registration method of the present invention in accordance with a preferred embodiment of the present invention.

### DETAILED DESCRIPTION OF THE PREFERRED EMBODIMENTS

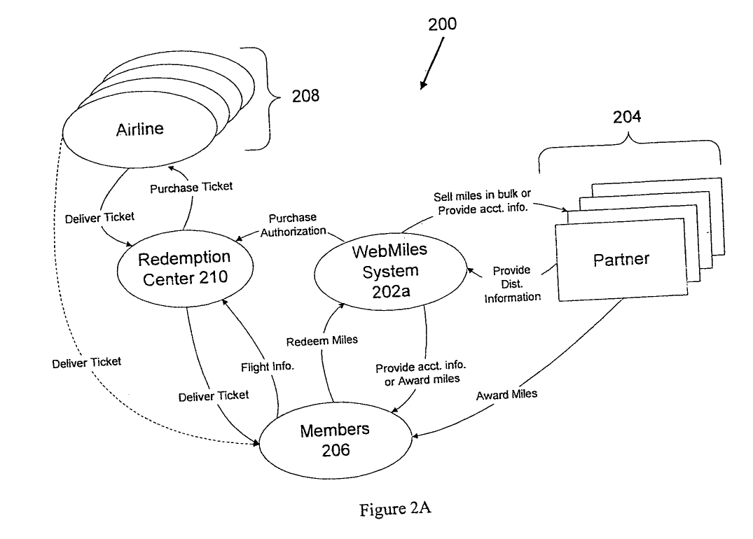

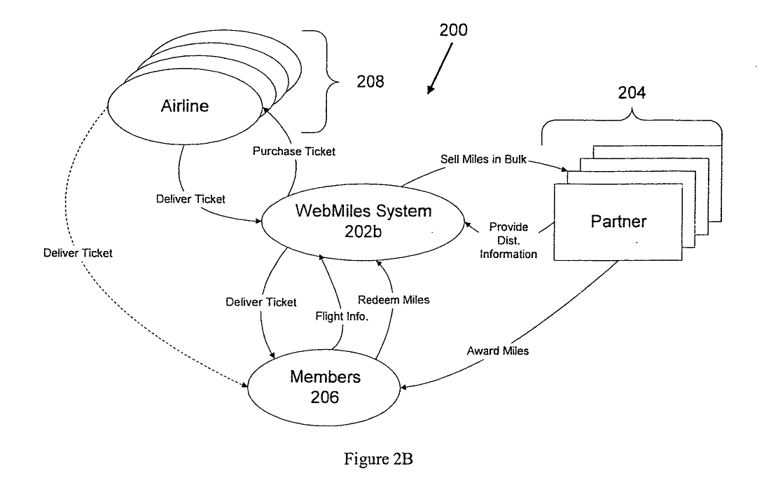

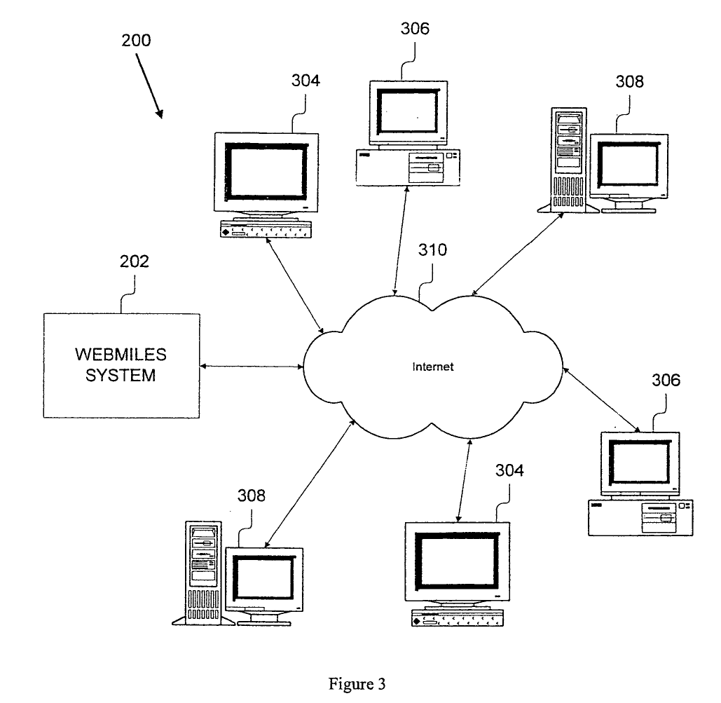

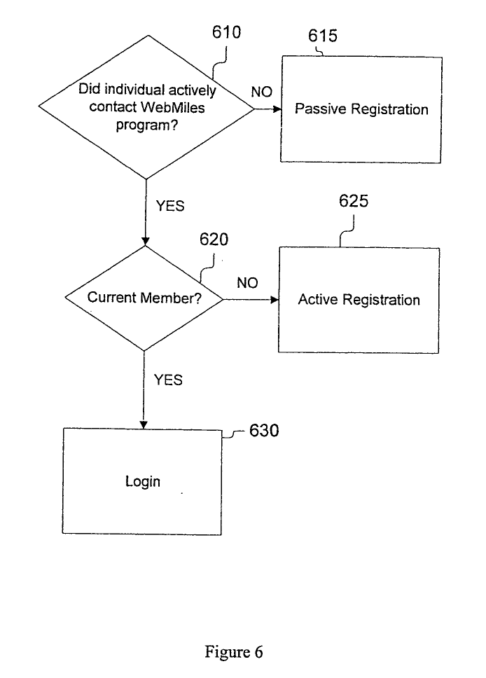

Referring now to FIGS. 2A-8, preferred embodiments of the present invention will now be described. A first and second embodiment will first be described with reference to FIGS. 2A and 2B. Then the system 202 and its coupling to other systems will be described with reference to FIGS. 3-5. Finally, a preferred registration method for operation of the system 202 will be described in detail with reference to FIGS. 6-8.

Preferred embodiments of the present invention are now described with reference to the figures where like reference numbers indicate identical or functionally similar elements. Also in the figures, the left most digits of each reference number corresponds to the figure in which the reference number is first used.

Referring now to FIG. 2A, the architecture for a first and preferred embodiment of a global generic mileage loyalty incentive system 200 according to the present invention is shown. The global generic mileage loyalty incentive system 200 offers global generic miles (WebMiles) as the incentive. WebMiles may be accumulated and exchanged for free travel in the form of airline tickets. The system 200 preferably includes a mileage tracking and reward system (WebMiles system) 202a, a plurality of partners 204, a plurality of members 206, a plurality of airlines 208 and a redemption center 210.

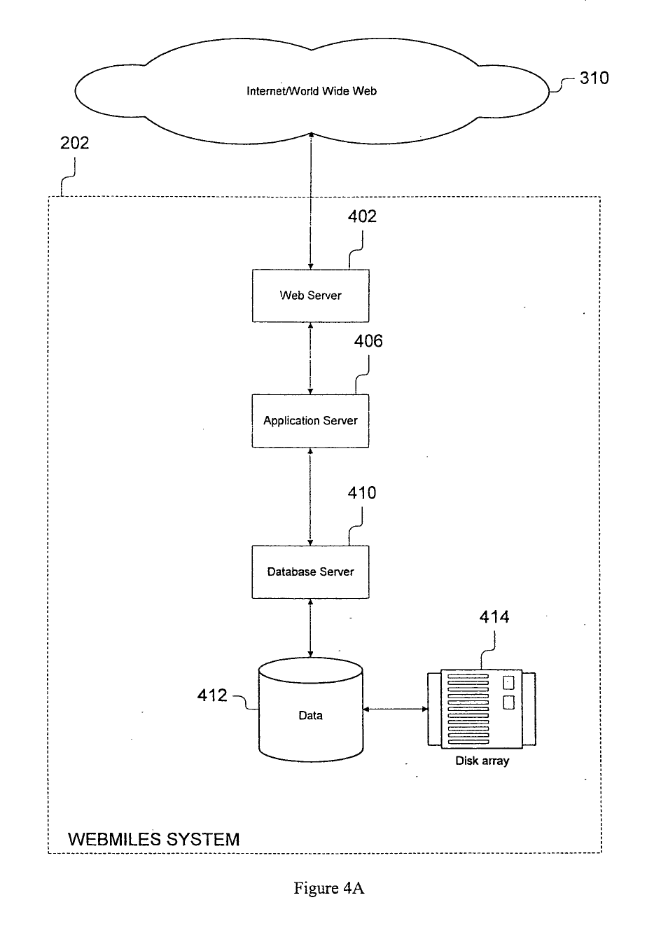

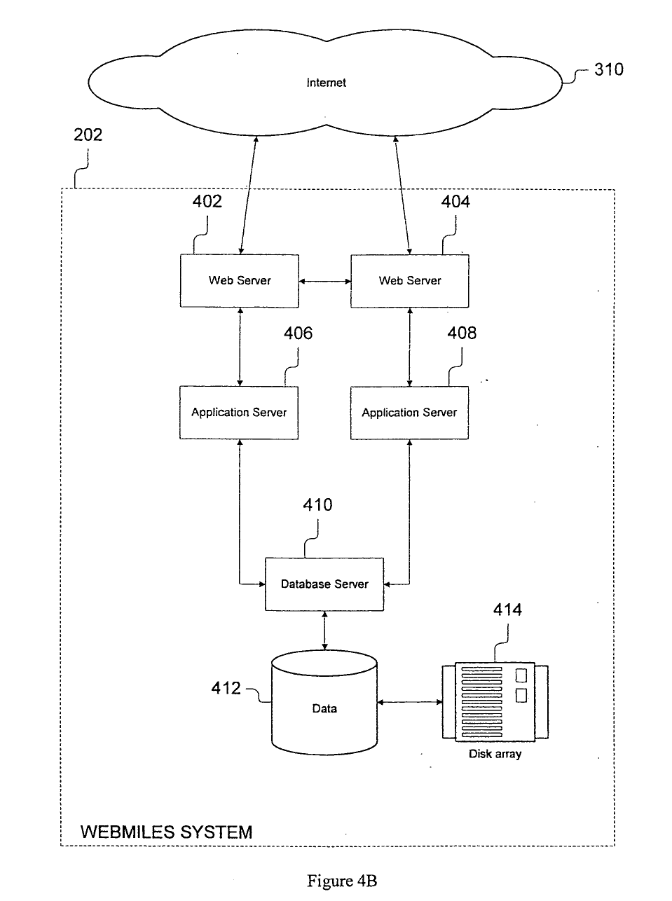

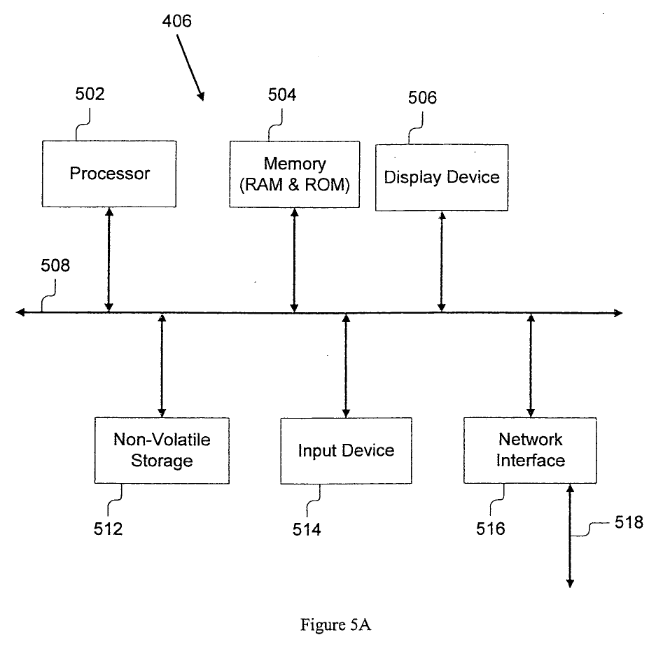

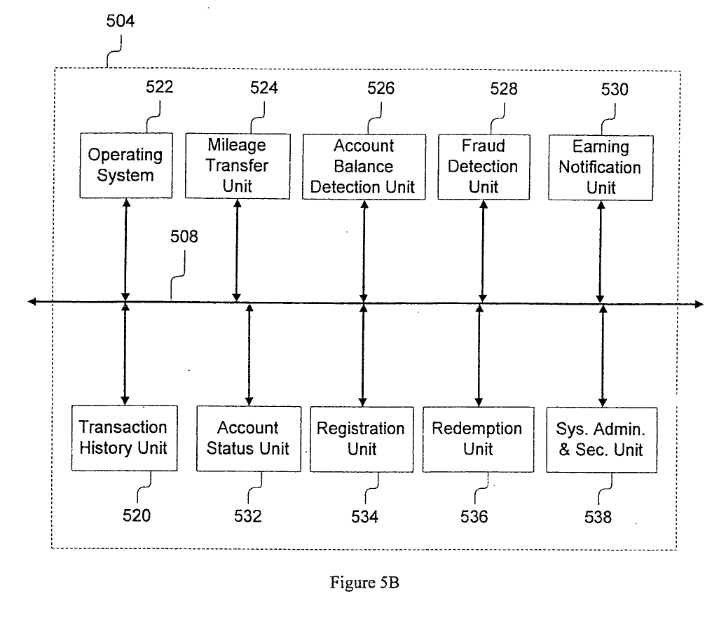

The WebMiles system 202a controls the transfer of mileage to and from partners 204 and/or members 206 and authorizes ticket purchases and delivery, as will be discussed in more detail below. The WebMiles system 202a also provides account information to partners 204, members 206 and others as requested. For each partner 204, member 206, redemption center 210 and airline 208, the WebMiles system 202a provides a unique identification number and account, which can be accessed by the respective party for tracking the number of WebMiles available. The WebMiles system 202a preferably is a plurality of web-enabled computers as will be described in more detail below with specific reference to FIGS. 4 and 5.

The partners 204 can be any individual or company that wants to generate loyalty and to do so offers WebMiles in conjunction with particular behaviors, most often purchasing behaviors, that the partner 204 wants to encourage. These behaviors both can be on the Internet (e.g., electronic interactions) or off the Internet (e.g., conventional business transactions). A partner 204 for the purposes of this application is also defined to include a computing device with access to the Internet 310. The present invention is particularly advantageous because it provides for a plurality of partners 204. In fact, the value and usefulness of the system 200 increases as the number of partners 204 increases.

The members 206 are potential customers and users, whose loyalty the partners 204 want to engender. Most often the members 206 will be consumers of goods and services. Like the partners 206, the members 204 include a computing device with access to the Internet, or are users with access to a computing device that provides Internet access.

The redemption center 210 preferably is at least one travel agent or a large travel service. The redemption center 210 is responsible for interfacing with the airlines 208 and purchasing tickets for members 206. The redemption center 210 communicates with the WebMiles system 202a to receive authorization and other security information for a particular member 206, and the redemption center 210 also communicates with the member 206 to secure information on the desired travel or flight information. While the present invention will be discussed below in the context of airline tickets as the incentive or reward provided by the redemption center 210, the present invention could be extended to include other travel related services such as hotel and lodging, rental cars and meals. The redemption center 210 communicates with the airlines 208 to secure the ticket and arrange for its delivery to the member 206. The redemption center 210 includes a computing device with access to the Internet for communication with the members 206, the WebMiles system 202a, and the airlines 208. The communication, however, also may be done by human operator and telephone in an alternate embodiment.

The system 202a works with a plurality of airlines 208. The airlines 208 preferably include all airlines world wide. Thus, the user may travel to any destination at any possible time. The present invention particularly is advantageous in the flexibility offered for travel. While the present invention will be described with reference to airlines 208 and tickets for air travel, the present invention also could be expanded to include any or all of the common transportation carriers such as trains, buses or ships. The present invention could be further expanded to include cruises, tours, hotels, resorts, car rentals and entertainment providers. The airlines 208 are of a conventional type including the ability to provide reservations, electronic ticketing and flight information to a human agent. The system 202a is particularly advantageous to these partners 206 and airlines 208 because of the system provides an incremental channel to a block of additional customers.

Partners 204, who wish to offer WebMiles, pre-purchase WebMiles in bulk and distribute the WebMiles to members 206 at their own discretion. Partners, therefore, can set the level of WebMiles a member 206 can earn for specific activities. Partners 204 benefit from their ability to use WebMiles as both a loyalty incentive and a promotional tool. An example of using WebMiles as a promotional tool would be if a partner were to offer double WebMiles for a selected product or service. Under normal circumstances, most partners 204 will offer WebMiles on the basis of one WebMile per dollar spent at the partner's location (e.g. Internet world wide web site). Participating partners 204 will receive real-time information regarding their account status via secure on-line connections with the WebMiles system 202.

Through a web site interface for the WebMiles system 202, members have on-line access to obtain information on the program features, redemption opportunities, and personal account status related to their WebMiles member account. When a member 206 has earned enough WebMiles for ticket redemption, the ticket may be redeemed on-line or via a toll-free telephone call. In a preferred embodiment, a ticket redemption center 210, such as a travel agent, processes the request for redemption of the WebMiles for an airline ticket. After identity verification, the redemption center 210 arranges the member's flight and initiates the mailing of the free round trip ticket to the member. Members 206 also may purchase additional tickets for family members or friends through the redemption center 210. In a preferred embodiment, the redemption center 210 purchases all tickets directly from the consumer's airline 208 of choice. By purchasing tickets on the open market, the redemption center 210 is able to offer WebMiles redemption for travel on any airline 208 in the world without typical frequent flyer mile restrictions.

As shown in FIG. 2A, there are a variety of interactions between the WebMiles system 202a, the plurality of partners 204, the plurality of members 206, plurality of airlines 208 and the redemption center 210. The interactions in the system 200 include (1) providing account information from the WebMiles system 202a to a partner 204; (2) sale of miles from the WebMiles system 202a to a partner 204; (3) providing award information from the partner 204 to the WebMiles system 202a; (4) awarding miles from a partner 204 to a member 206 (This awarding preferably is done electronically, however, in alternate embodiments this awarding could be done by paper coupon, electronic coupon or certificate. Further, awarding may include confirmation by some type of physical receipt or record.); (5) providing account information from the WebMiles system 202a to a member 206; (6) awarding miles from the WebMiles system 202a to a member 206; (7) requesting or redeeming miles by a member 206 to the WebMiles system 202a for the award of an airline ticket; (8) sending an authorization to purchase an airline ticket from the WebMiles system 202a to the redemption center 210; (9) sending flight and other travel information from the member 206 to the redemption center; (10) purchasing the ticket from the airline 208 by the redemption center 210; (11) delivery of the ticket from the airline 208 to the redemption center 210; (12) delivery of the ticket from the airline 208 to the member 206; and (13) delivery of the ticket from the redemption center 210 to the member 206, which can be accomplished by providing an electronic ticket.

The above functionality provides a generic mileage loyalty incentive program that is particularly advantageous because through the use of electronic transactions, much of the administrative cost associated with a program is eliminated. The program also is advantageous because rewards for travel can be used on any airline, at any time, and partners 204 each have the flexibility to provide multiple ways for members 206 to earn miles.

Referring now to FIG. 2B, a diagram of a second embodiment for the global generic mileage loyalty incentive system 200 of the present invention is shown. The second embodiment of the system 200 is similar to the first embodiment, thus like reference numerals are used for like components in FIG. 2B. The most notable difference between the first embodiment 202a and the second embodiment 202b is that the redemption center 210 is eliminated in the second embodiment. The redemption center 210 instead is integrated as part of the WebMiles system 202b. In this embodiment, the WebMiles system 202b includes modules or units to communicate with the airlines 208. This embodiment is preferably done by way of application programs that interface with the WebMiles system 202b to the computers for ticketing and reservation of the airlines 208. Thus, the interactions 8-11 and 13 noted above are replaced by interactions where the WebMiles system 202b communicates with the member 206 to provide airline ticket. In particular, the second embodiment includes such interactions as: (1) sending flight and other travel information from the member 206 to the WebMiles system 202b; (2) purchasing the ticket from the airline 208 by the WebMiles system 202b; (3) delivery of the ticket from the airline 208 to the WebMiles system 202b; and (4) delivery of the ticket from the WebMiles system 202b to the member 206. While preferably the processing within the WebMiles system 202b is electronic, some of the interactions may be done manually and combined with the web interfaces with the members 206 and partners 208.

Referring now to FIG. 3, a high-level block diagram of the system 200 constructed according to the present invention is shown. The system 200 preferably comprises the WebMiles system 202, a plurality of workstations 304, a plurality of personal computers 306 and a plurality of servers 308 coupled to communicate with each other via the Internet (e.g. world wide web) 310. The workstations 304, personal computers 306 and servers 308 are used by partners 204, members 206, and the redemption center 210 to access and communicate with the WebMiles system 202. The workstations 304 and servers 308 are of a conventional type known to those skilled in the art, and are web enabled to include a browser such as Internet Explorer by Microsoft Corporation of Redmond, Wash. or Navigator by Netscape Communications Corporation of Mountain View, Calif. Similarly, the personal computers 406 are of a conventional type such as the IBM compatible based on an X86 processor from Intel Corporation of Santa Clara, Calif. or a multi-processor system using a UNIX operating system.

Referring now to FIG. 4A, the WebMiles system 202 is shown in more detail. The preferred hardware architecture for the WebMiles system 202 includes a first web server 402, a first application server 406, a database server 410 and a disk array 414. The first web server 402 is preferably conventional types for providing access to the Internet 310 including the hosting of web pages and providing for the retrieval of data from connected users. The first web server 402 preferably has an independent connection to the Internet 310. The first web server 402 is, for example, a Sun Ultra E250 server including Netdynamics web sever software by Sun Microsystems of Palo Alto, Calif.

The first web server 402 is coupled to a respective application server 406. The first application server 406 is responsible for running application software that provides the functionality of the system 202 described abov. with reference to FIGS. 2A-3 and that will be described below particularly with reference to FIGS. 5-8. The first application servers 406 is a conventional type of server, but includes the novel software of the present invention. For example, the first application server 406 is a Sun Ultra Enterprise 450 server. Essentially, the first application server 406 is connected and operates under the control of business logic that provides the functionality for maintaining the generic mileage loyalty program and processing transactions and interactions that have been noted above. The first application server 406 also is coupled to a database server 410.

The database server 410 also is a conventional server and may be a Sun Ultra Enterprise server. The database server 410 controls the storage and retrieval of data 412 (e.g. membership information) to and from the database on the disk array 414. The database server 410 preferably also includes database software such as Oracle 8 database software for creation of a conventional database. The database server 410 maintains transactions records, user profiles, transactions in response to instructions received from the application server 406. The database server 410 also may include additional software to perform data mining on the database as well as registration processes.

Referring now to FIG. 4B, a second and alternate embodiment of the hardware architecture for the system 202 is shown. The second alternate embodiment includes a second web server 404 and a second application server 408 in addition to the components identified above for the first embodiment. The first and second web servers 402, 404 are preferably conventional types for providing access to the Internet 310 including the hosting of web pages and providing for the retrieval of data from connected users. Each of the first and second web servers 402, 404 preferably has an independent connection to the Internet 310. The first and second web servers 402, 404 are preferably also coupled to each other for load balancing purposes for times when one server 402, 404 is handling a higher volume of traffic than the other. The first and second web servers 402, 404 are, for example, Sun E250 servers including web server software from Netdynamics. Those skilled in the art will recognize that while only two web servers 402, 404 are show, the system 202 may be modified as needed to provide additional web servers, each providing another connection to the Internet 310. In this second embodiment, each of the first and second web server 402, 404 is coupled to a respective application server 406, 408. The first and second application servers 406, 408 are responsible for running application software that provides the functionality of the system 202 described above with reference to FIGS. 2A-3 and that will be described below with particularity in FIGS. 5-8 below. The first and second application servers 406, 408 are each a conventional type of server, but include the novel software of the present invention. For example, the first and second application servers 406, 408 are Sun Ultra Enterprise 450 servers. Essentially, the first and second application servers 406, 408 are connected and operated under the control of business logic that provides the functionality for maintaining the generic mileage loyalty program and processing transactions and interactions that have been noted above. Each of the first and second application servers 406, 408 also is coupled to a database server 410.

FIG. 5A shows a high-level block diagram of a preferred embodiment for the application server 406 of the present invention. While the following description will focus on the first application sever 406, those skilled in the art will recognize that the second application server 408 preferably has a similar hardware and software configuration. The application server 406 preferably comprises one or more central processing units or processors 502 that connect with a memory 504, an output or display device 506, a data storage device 512, an input device 514 and a network interface 516. The processor 502, memory 504, output device 506, data storage device 512, input device 514 and network interface 516 preferably are coupled in a von Neuman type architecture via a bus 508 such as a personal or mini computer. The processor 502 is preferably a microprocessor such as a Sun UltraSparc, Motorola PowerPC or an Intel Pentium III; the output device 506 is preferably a video monitor and the input device 514 is preferably a keyboard and mouse-type controller. The memory 504 preferably includes random access memory (RAM) and read-only memory (ROM). The processor 502 is coupled to the data storage device 512 such as a hard disk drive in a conventional manner. The processor 502 also is coupled to the network interface 516 such as Ethernet in a conventional manner for connection to a network via line 518 and other computers such as via a local area network, wide area network or the Internet 310. Those skilled in the art will realize that a variety of different networking configurations and operating systems including Token Ring, Ethernet, or Arcnet may be used and that the present invention is independent of such use. While the first application server 406 has been noted to preferably be a Sun Ultra Enterprise server, those skilled in the art will realize that the first application server 406 could also be implemented as any one of a variety of other computers such as those made by Apple, Digital Equipment Corporation, IBM, or IBM compatibles. The processor 502 operates under the control of the memory 504 to process the transactions and interaction as will be described in more detail below.

Referring now to FIG. 5B, the preferred embodiment of the memory 504 of the application server 406 is shown in more detail. The memory 504 preferably comprises an operating system 522, a mileage transfer unit 524, an account balance detection unit 526, a fraud detection unit 528, an earning notification unit 530, a transaction history unit 520, an account status unit 532, an advertising unit (not shown), a registration unit 534, a redemption unit 536, a unit for system administration and security 538, and an award notification unit (not shown). The memory 406 also may include a variety of different application programs including, but not limited to, web page processing, data processing, server interface and communication programs.

These routines control the interaction of the partners 204 and the members 206 with the system 202.

The operating system 522 is a conventional type such as Sun Solaris. Those skilled in the art will realize how the present invention may be readily adapted for use with other operating systems such as UNIX, Macintosh System Software, DOS, Windows or Windows NT. The mileage transfer unit 524 preferably comprises the routine for transferring miles from the system 202 to a partner 204. The mileage transfer unit 524 also processes transactions to transfer miles from a partner 204 to a member 206. The account balance detection unit 526 includes routines for processing mile transfer transactions, and determining whether additional notifications should be generated. The account balance detection unit 526 preferably generates electronic notifications in two instances: 1) if a partner has a mileage account balance less than a preset threshold; and 2) if a member has accumulated miles sufficient to redeem the miles for an award. The fraud detection unit 528 includes the routines to control the processor 602 to detect fraudulent transactions. As mileage transfers are processed, the system 202 performs tests to verify the accuracy of the transactions and ensure that miles are correctly awarded to the proper members 206 as the transactions are received from the partner 204. The earning notification unit 530 includes routines for notifying the members 206 of opportunities to earn miles. The earning notification unit 530 preferably includes routines for proactively directing members 206 to partners 204 and to perform specific behaviors to earn miles to reach an award level. This routine can include both identification of the behavior as well as notification of possible travel destinations that are possible with a given award level. The earning notification unit 530 also includes the generation of emails and other communications with the members 206. For examples, such communications may include last minute deals, offers of bonus miles, specials, sales or other incentives provided based on partner inventory or partner input on behavior the partners are interested in motivating. The earning notification unit 730 also can generate and maintain a chat room, and provide messages on an automatic basis listing various strategies to earn more or the maximum number of miles, as well as what other members 206 have done to earn miles. The transaction history unit 720 includes routines for capturing all transactions processed by the system 202. The transaction history unit 720 creates a record of all processed transactions that can be used at a later time to identify abnormalities in transactions, and also as a confirmation records in response to inquiries from either partners 204 or members. The account status unit 732 includes the routines and templates for presenting account status data to a requesting partner 204, member 206 or the redemption agent 210. The account status unit 732 includes routines for querying the database server 410 for data and for using the returned data by inserting it into HTML web pages for presentation to the requesting partner 204, member 206 or the redemption agent 210. The advertising unit (not shown) includes modules and routines for processing advertising. Such processing includes storing and updating advertising stored in the database 412. It also includes the presentation of such advertising such as banner advertising in a conventional manner, but in conjunction with the presentation of other information to the partners 204 and members 206. The advertising unit also includes a correlation or target unit (not shown) so that particular advertising may be targeted to a particular partner 204 or member 206 based on their profile in the database 412 or based on the interaction or activity for which they are communicating with the system 200. The registration unit 534 includes software modules and routines for controlling the first application server 406 for processing the passive and active registration of prospective new members to the system 202. The routines underlying the software modules of the registration unit 534 will be discussed in more detail with regard to FIGS. 6-8. The redemption unit 536 includes software modules and routines for controlling the first application server 406 for processing requests from members 206 to redeem accrued miles for airline tickets. The redemption unit 536 includes routines for handling the redemption of miles in an entirely electronic process, where the system 202, the member 206 and the redemption agent 210 interact by electronic means such as via the Internet and browsers. The redemption unit 536 also includes routines for handling the redemption of miles in a hybrid environment where some of the steps of the method are performed electronically and some of the steps are performed by a human operator or user. The memory 504 includes a unit for system administration and security 538. This unit 538 includes the routines necessary for maintenance of the system, back office operations, and monitoring. This unit 538 also handles the initialization of accounts, the addition of new members 206 and partners 204, and the security such as the maintenance of passwords. This routine generally is performed in a conventional manner as will be understood to those skilled in the art.

Methods and Software for the Registration Unit

Referring now to FIGS. 6-8, the preferred methods for the operation of the registration unit 534 of the system 202 will be described in more detail.

FIG. 6 illustrates a flowchart of a preferred registration method for the operation of the registration unit 534 of the present invention, which facilitates the registration of a greater number of new members to the WebMiles system 202. The method begins with a determination 610 as to whether the individual directly (actively) has contacted the WebMiles system 202. If the individual actively has contacted the system 202 either directly (e.g. by selecting the web site of the system 202) or via a partner 204 (e.g. an on-line merchant, which redirects the individual, who has clicked on an icon related to the WebMiles system, to the web site of the system 202), then the application server 406 determines 620 whether the individual is a current member of the system 202. This process includes the application server 406 capturing the individual's e-mail address and comparing that address with the member profiles stored within the database server 410. In a preferred embodiment, the application server 406 captures the individual's e-mail address by either retrieving the e-mail address from a cookie, which is stored locally upon the individual's computer, obtaining the e-mail address from information forwarded from a partner 204 or requesting the individual to manually enter his/her e-mail address. Cookies also can be used to store one or more e-mail addresses of different individuals, who use the same computer. In such an alternative instance, each individual would have to manually choose one of the existing e-mail addresses as the e-mail address, which the application server 406 will use to determine whether the individual is already a member. In a preferred embodiment, the member's identification with the system 202 is directly linked to the e-mail address associated with the member 206.

If the e-mail address from the individual matches one of the membership identifiers (e.g. e-mail addresses) within the member profiles, the application server 406 has identified an individual, who is a current member 206. The application server 406 will respond to this match by initiating a conventional login process 630 where the member 206 enters his/her member identifier (e.g. e-mail address) and password, thereby entering his/her specific membership account. If the individual is not a current member, an active registration process 625 is initiated.

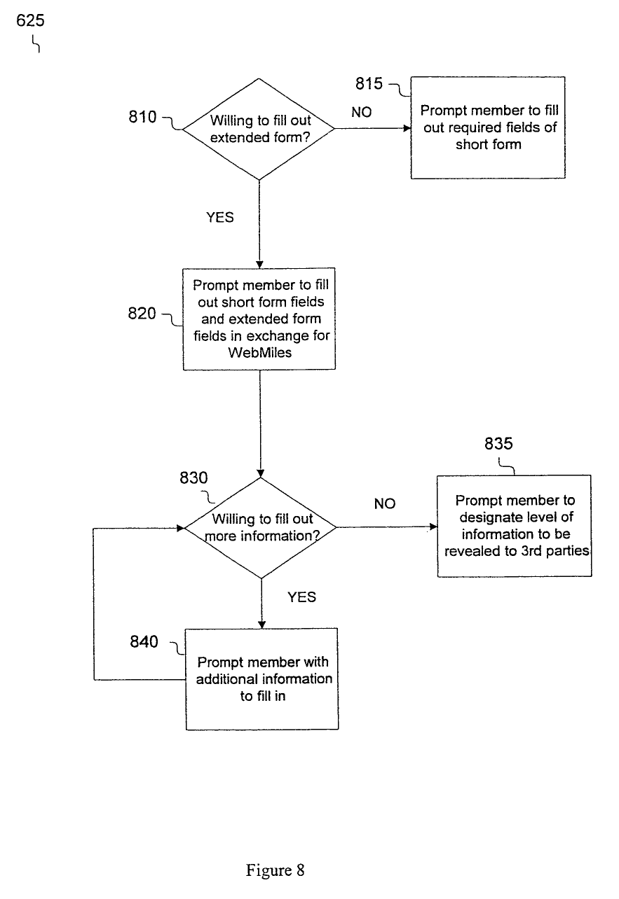

FIG. 8 illustrates a preferred embodiment of the active registration process of the present invention where a partner of the WebMiles program redirect individuals, who have accessed the partner's web site, to actively register on-line as a new member at the WebMiles web site. In a preferred embodiment, when an individual accesses a partner's web site, which is operated by an independent web server, an icon will designate the partner as associated with the WebMiles program. Associated with this icon will be an incentive for the individual to click upon the icon to initiate a new active short or extended registration form with the WebMiles system 202.

By affirmatively clicking upon the WebMiles icon, which is embedded within the partner's web site, the individual is expressing a desire to register with the WebMiles system 202. In response to the individual's actions, the partner's web site redirects the individual to the WebMiles program's web site where the registration information is gathered. With regard to redirecting the individual to WebMiles, the redirect causes various variables to be forwarded to the WebMiles program's web site including the individual's e-mail address, the partner's web site address and the amount of WebMiles offered to the individual by the partner for registering to WebMiles via the partner's web site. In a preferred embodiment, this manner of registering is achieved by providing a pop up screen for the individual to complete, which includes fields related to the active registration process.

Once this initial information is captured by the WebMiles program's web site, this information is used to identify the individual as willing to actively register 610 with the system 202 as well as whether the individual is a current member 620. In addition, such information can assist the system 202 in determining how many WebMiles to reward the individual for registering and to which partner's account the WebMiles will be debited. In addition to the variables being forwarded through the URL to the WebMiles program's web site, additional information can be obtained from the WebMiles cookie that may be present on the individual's computer.

In particular, when an individual's e-mail address has been obtained by WebMiles, the membership database is queried by the WebMiles program's web server and determines whether the information provided by the partner 204 is a new member or whether it is an individual who already has registered 620. If the individual is a new member, the WebMiles offered by the partner are deducted from the partner's account and credited to the new member. If the WebMiles program is supplementing some amount of these WebMiles, those WebMiles are credited back to the partner's account.

By having the individual register through the partner's web site, the partner can offer varying amounts of WebMiles to encourage individuals to register with the WebMiles program. To remunerate the partner 204 for assisting the WebMiles system 202 register new members, the WebMiles system 202 can have an arrangement with the partner 204 to offer WebMiles to the partner 204 at a discounted rate. In this manner, the partner has greater control over the level of incentive its customer has to register for the WebMiles system 202 and an additional incentive for the individuals to then purchase products on the partner's site because of the amount of WebMiles offered by that partner 204. Alternatively, the partner 204 also may benefit from having individuals register for the system 202 through the partner's web site by serving as the interface for individuals interested in Web Miles. In such a manner, the partner's web site will receive greater levels of traffic, thereby increasing the possibility of individuals purchasing products or services from the partner 204 or of the partner 204 receiving additional levels of advertising revenue.

As illustrated in FIG. 8, the active registration process of a preferred embodiment begins with the member being asked 810 whether he/she is willing to fill out an extended registration form (e.g. required information plus additional personal information). In a preferred embodiment, this inquiry typically also is accompanied with offering an incentive of WebMiles to encourage the new member to complete as much information as he/she is comfortable completing in the extended form. If the member declines to complete the extended registration form, the member is requested 815 to fill out the required fields of the short form. To reward the consumer for completing at least the short enrollment form in an accurate manner, a certain number of WebMiles (e.g. 500 WebMiles) can be offered.

If the member is willing to complete the extended form, based upon the recognition that different consumers have different tolerances as to how much information to provide a third-party, different levels of WebMiles will be offered 820 for different degrees of completion of the extended registration form. The amount of WebMiles will increase in amount with the level of personal information provided to the company. In a preferred embodiment, this exchange of WebMiles for personal information can occur in an iterative manner, where after the member provides some additional information in the extended form, the system 202 further inquires 830 into whether the member would be willing to fill out additional information for additional WebMiles. If the member is willing to provide additional information, the system 202 prompts 840 the member for the additional information to provide.

A predetermined hierarchy for the worth of each field is determined by the system administrator of the WebMiles system 202 and these values are displayed to the member to entice him/her to provide as much information as the member feels comfortable providing. To further entice the member to complete additional sections of the form, there can be a feedback mechanism, which will inform the member of the number of WebMiles that the member has earned for completing each specifically designated field of the registration form. By giving the member the ability to determine his threshold level for providing information, the member is given a certain degree of control back with regard to the dissemination of personal information. In return for WebMiles, the member determines the degree of control over his information he is willing to give up.

In addition to encouraging the member to complete as much of the membership profile as the member is comfortable completing, the member also has the option of designating 835 the information provided as only available for demographic purposes and not for direct marketing. In particular, when the member has expressed an unwillingness to complete any additional information on the extended form, the member is given the opportunity to designate 835 what portion of the extended form is not confidential and can be shared. This mechanism provides multiple levels of privacy and satisfaction for the member 206 by allowing the member to determine how much information he/she will provide to the WebMiles system 202, placing a WebMiles value upon this information for the member to consider and allowing the member to designate information as only available for demographic information.

In a preferred embodiment, the following fields are included within the extended form and short form.

| Field | Form | Required |
|---|---|---|
| First name | Short | Yes |
| Middle name | Short | No |
| Last name | Short | Yes |
| Salutation | Short | Yes |
| Preferred language | Short | Yes |
| Address | Short | No |
| City | Short | No |
| State | Short | No |
| Postal code | Short | Yes |
| Country | Short | Yes |
| Daytime phone number | Extended | No |
| Evening phone number | Extended | No |
| Fax number | Extended | No |
| Account identifier | Short | Yes |
| (e.g. e-mail address) | | |
| Password | Short | Yes |
| Security question | Short | Yes |
| Security answer | Short | Yes |

When the new member provides a password for his/her account, the encrypted password is stored in a password field of a database and an application validates a member's password by comparing the encrypted values. Based upon this paradigm, “forgotten” passwords cannot be recovered, however, plain-text passwords cannot be viewed by anyone, even the system administrator.

The security question and answer, which are desired in a preferred embodiment, can be used to verify a member's identity when dealing with redemption of WebMiles. The security question and answer also allows members to select a new password if they have forgotten their old password. Furthermore, off-line access (e.g. when a member contacts the WebMiles system 202 or an authorized WebMiles partner 204 via phone) to such information is available to members only after the security question is answered. In addition, the personal profile information in the short form or the extended form, however, cannot be saved until the member supplies all information, which has been designated by the WebMiles system 202 as required.

One skilled in the art will recognize that in addition to the above fields within the extended registration form, any additional personal information can be included as a field. For example, in an alternative embodiment, additional information, such as traveler profile information, can be provided. Such information may be helpful to a ticketing agent as the agent books the member's travel. Such information also can include seating preference, meal preference, smoking preference, frequent flyer memberships (e.g. airline, member number), rental car information, driver license number and state of issue, rental car company memberships (e.g. company, membership number), hotel information (e.g. smoking preference, bed size preference, special requests, hotel memberships, company, membership number), international travel information (e.g. passport number, passport expiration date, passport place of issue, citizenship), emergency contact information (e.g. contact name, contact phone number), and special medical needs.

Once the registration is complete, the application server 406 transmits an acknowledgment e-mail message to the new member to acknowledge that registration and activation of the new member's account has been completed and to remind the new member also of his/her membership identifier and password. Should the member wish to change his or her personal profile information, which is associated with the membership account, the member will have to enter the membership identifier and password through a conventional login procedure with the application server 406.

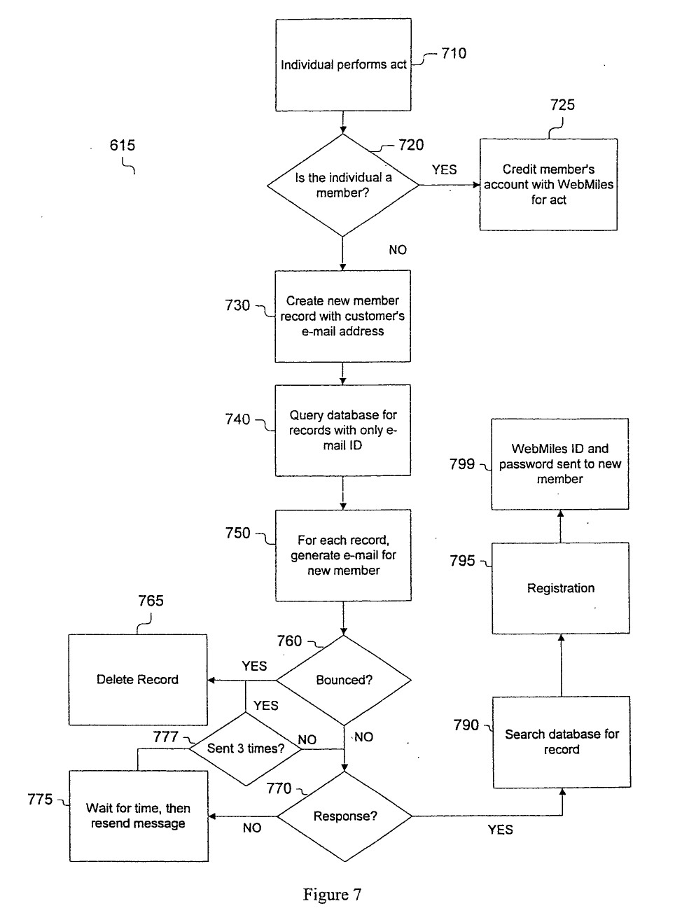

FIG. 7 illustrates the passive registration method 615 of a preferred embodiment of the present invention where an individual is identified and is encouraged to register as a member of the system 202. The method begins with the individual performing some act 710, such as purchasing a product or service on-line at the web site of one of the partners 204. Such an action will result in the partner 204 capturing the individual's e-mail address. These captured e-mail addresses are then transmitted at the end of each day within a batch file to the system 202. This batch file also can include information regarding any WebMiles, which were awarded by the partner 204 to that specific individual during the day for performing such behaviors as purchasing items or providing the partner 204 with personal information. The application server 406 compares 720 each of these e-mail addresses to the membership identifiers, which are stored within the membership profiles within the database server 410. As previously discussed, in a preferred embodiment, the membership identifier corresponds to a member's e-mail address. Therefore, if the individual's e-mail address, which is contained within the partner's batch file, corresponds to one of the membership identifier's within the membership database, the application server 406 has confirmed that the individual already is a member of the system 202. In such a situation, the application server 406 will credit 725 that member's account with the specific number of WebMiles, which the individual earned from the partner 204. The individual then will receive a confirmation of the WebMiles credit via an e-mail, which is sent to the e-mail address on file for that individual.

If the e-mail address does not correspond with a membership identifier within the membership database, the application server 406 creates 730 a new record within the database, which includes the individual's e-mail address as the membership identifier. At a predesignated later time, the application server 406 queries 740 the membership database to identify all of the new member records, which only include the membership identifier. For each of these records, the application server 406 activates a process (e.g. via Sun Microsystem's JAVA programming language), which opens a Simple Mail Transfer Protocol (“SMTP”) socket to a mail server and an e-mail is generated that is transmitted 750 to the individual. The e-mail is intended to inform the individual that he/she has received WebMiles for an activity (e.g. purchasing a product or service on-line at a partner's web site) and that to activate his/her WebMiles account, he/she has to register with the system 202. The system 202 then waits 760 to determine whether the e-mail is bounced back to the application server 406.

If the e-mail bounces back 765 to the application server 406, the new member record is removed from the membership database. If the e-mail does not bounce back to the application server 406, the application server 406 determines whether a response has been received 770 for each new member account. If the new member does not respond, the application server 406 waits a predesignated amount of time and then resends 775 the e-mail. If the new member does not respond 777 after a certain number (e.g. three times) of resends of the e-mail, this new member record also is deleted 765 from the membership database.

If an individual does receive the e-mail and intends upon responding, the individual clicks upon the web site link, which is embedded within the e-mail message. The web site link includes a URL address, which contains the web site address of the WebMiles system 220 as well as the new member's identifier (e.g. e-mail address). Since the member's identifier is embedded into the URL, the system 202 will be able to automatically 790 search the database for the new member's record, when the new member contacts the system 202. Once the new member's record is identified, the new member 206 is asked to provide 795 information such as his or her address and phone number in order to register and activate his/her membership account.

In a preferred embodiment, this registration 795 is very similar to the active registration process 625. For example, the registration begins with the member 206 being asked 810 whether he/she is willing to fill out an extended registration form (e.g. required information plus additional personal information). A similar incentive of WebMiles also is used in a preferred embodiment to encourage the new member to complete as much information as he/she is comfortable completing in the extended form. If the member declines to complete the extended registration form, the member is requested 815 to fill out the required fields of the short form. To reward the consumer for completing at least the short enrollment form in an accurate manner, a certain number of WebMiles (e.g. 500 WebMiles) can be offered.

If the member is willing to complete the extended form, based upon the recognition that different consumers have different tolerances as to how much information to provide a third-party, different levels of WebMiles will be offered 820 for different degrees of completion of the extended registration form. The amount of WebMiles will increase in amount with the level of personal information provided to the company. In a preferred embodiment, this exchange of WebMiles for personal information can occur in an iterative manner, where after the member provides some additional information in the extended form, the system 202 further inquires 830 into whether the member would be willing to fill out additional information for additional WebMiles. If the member is willing to provide additional information, the system 202 prompts 840 the member for the additional information to provide. One skilled in the art will recognize that alternative registration methods can be used in order to obtain the desired information of the new member 206.

While the present invention has been particularly shown and described with reference to preferred embodiments and several alternate embodiments relating to on-line systems, one skilled in the art will understand that various changes in form and details can be made therein without departing from the spirit and scope of the invention. Such modifications include utilizing the system and methods describe in the various embodiments in a non-on-line context, such as via a telephone.

What is claimed is:

1. A method for implementing a reward program in which customers are selectively awarded generic miles, the method comprising:
establishing an account associated with a customer; and
crediting the account with one or more generic miles in exchange for an activity performed by the customer, the generic miles being redeemable for credit to the customer towards services from one or more of a plurality of airlines.

2. The method of claim 1, further comprising establishing an account associated with a partner.

3. The method of claim 2, further comprising crediting the account associated with a partner with a block of generic miles.

4. The method of claim 3, further comprising deducting at least a portion of the generic miles credited to the account associated with the customer from the account associated with the partner.

5. The method of claim 4, wherein the deducting is performed in response to a visit by the customer to the website of the partner.

6. The method of claim 4, wherein the deducting is performed in response to a purchase by the customer of a product or service from the partner.

7. The method of claim 4, wherein at least one of the crediting an account associated with the partner, crediting an account associated with the customer, and deducting at least a portion of the generic miles credited involves the Internet.

8. The method of claim 4, further comprising notifying a partner from whose account generic miles have been deducted of when the balance of generic miles in that account has reached a predetermined threshold.

9. The method of claim 1, further comprising notifying a customer whose account has been credited that the number of generic miles in the credited account has reached a redeemable level.

10. The method of claim 1, further comprising detecting fraud by verifying that the correct account associated with a partner is deducted.

11. The method of claim 1, further comprising detecting fraud by verifying that the correct account associated with a customer is credited.

12. The method of claim 1, wherein establishing an account associated with a customer comprises actively registering the customer in the reward program in response to a visit by the customer to a website associated with the reward program.

13. The method of claim 12, wherein actively registering the customer in the reward program comprises acquiring personal information about the customer.

14. The method of claim 13, further comprising crediting the account associated with the customer with generic miles commensurately with the quality and/or quantity of the personal information.

15. The method of claim 14, further comprising establishing an account associated with a partner, crediting the account associated with a partner with a block of generic miles, and deducting at least a portion of the generic miles credited to the account associated with the customer from the account associated with the partner.

16. The method of claim 14, wherein the personal information is acquired through completion of an on-line short form.

17. The method of claim 14, wherein the personal information is acquired through completion of an on-line extended form.

18. The method of claim 2, wherein establishing an account associated with a customer comprises actively registering the customer in the reward program in response to a visit by the customer to a website associated with the partner.

19. The method of claim 18, further comprising acquiring personal information about the customer.

20. The method of claim 19, further comprising crediting the account of the customer with generic miles commensurately with the quality and/or quantity of the personal information.

21. The method of claim 20, further comprising crediting the account associated with a partner with a block of generic miles, and deducting at least a portion of the generic miles credited to the account associated with the customer from the account associated with the partner.

22. The method of claim 20, wherein the personal information is acquired through completion of an on-line short form.

23. The method of claim 20, wherein the personal information is acquired through completion of an on-line extended form.

24. The method of claim 2, wherein establishing an account associated with a customer comprises passively registering the customer in the reward program in response to a purchase by the customer of a product or service provided by the partner.

25. The method of claim 24, wherein the product or service are purchased on-line.

26. The method of claim 25, further comprising capturing an e-mail address of the customer in response to the on-line purchase.

27. The method of claim 26, further comprising determining from the captured e-mail address if an account associated with the customer has already been established, and establishing an account associated with the customer only if an account associated with the customer has not already been established.

28. The method of claim 24, further comprising acquiring personal information about the customer.

29. The method of claim 28, further comprising crediting the account of the customer with generic miles commensurately with the quality and/or quantity of the personal information.

30. The method of claim 29, further comprising crediting the account associated with a partner with a block of generic miles, and deducting at least a portion of the generic miles credited to the account associated with the customer from the account associated with the partner.

31. The method of claim 29, wherein the personal information is acquired through completion of an on-line short form.

32. The method of claim 29, wherein the personal information is acquired through completion of an on-line extended form.

33. The method of claim 27, further comprising generating and sending an e-mail to the captured e-mail address informing the customer that an account associated with the customer has been established and needs to be activated.

34. The method of claim 33, wherein the account associated with the customer is deleted if said account is not activated.

35. The method of claim 33, wherein account activation is performed by a visit to a website associated with the award program.

36. A system for rewarding customer behavior comprising:
a generic miles system including a computer configured to establish an account associated with the customer, to credit the account with generic miles in response to particular behavior by the customer, and to track credited generic miles; and
a redemption system configured to redeem the generic miles credited to the customer for credit towards services from one or more of a plurality of airlines.

37. The system of claim 36, wherein the particular behavior comprises providing personal information.

38. The system of claim 36, wherein the computer credits the account commensurately with the quality and/or quantity of personal information.

39. The system of claim 36, wherein the redemption system comprises a computer adapted to automatically redeem the generic miles from the one or more airlines.

40. The system of claim 36, wherein the computer is adapted to establish an account associated with a partner and to credit the account with a block of generic miles.

41. The system of claim 40, wherein the computer deducts at least a portion of the generic miles credited to the account associated with the customer from the account associated with the partner.

42. A system for rewarding the behavior of one or more customers in relation to one or more partners comprising:
a generic miles system including a computer configured to establish an account associated with a customer and an account associated with a partner, to credit the accounts with generic miles, to track the credited generic miles, and to deduct generic miles credited to an account associated with a partner; and
a redemption system configured to redeem the generic miles credited to the customer for credit towards services from one or more of a plurality of airlines.

43. The system for rewarding of claim 42, wherein the computer comprises an application server having a memory for storing computer instructions and a processor for implementing the instructions.

44. The system for rewarding of claim 43, wherein the memory comprises a mileage transfer unit implementing the crediting of the accounts associated with the customer and partner.

45. The system for rewarding of claim 43, wherein the memory comprises an account balance detection unit implementing the tracking of the accounts associated with the customer and partner.

46. The system for rewarding of claim 45, wherein the account balance detection unit notifies the partner when the balance of generic miles in the account associated with the partner has reached a predetermined threshold.

47. The system for rewarding of claim 43, wherein the memory comprises an earning notification unit adapted to notify the customer when the balance of generic miles in the account associated with the customer has reached a redeemable level.

48. The system for rewarding of claim 43, wherein the memory comprises a fraud detection unit adapted to verify that a customer account has been correctly credited.

49. The system for rewarding of claim 43, wherein the memory comprises an account status unit, a transaction history unit, an advertising unit, a registration unit, and a system administration and security unit.

50. The system for rewarding of claim 43, wherein the memory comprises a redemption unit defining the redemption system, the redemption unit automatically redeeming the generic miles from the one or more airlines.

51. The system for rewarding of claim 43, wherein the computer comprises a web server providing access to the Internet.

52. The system for rewarding of claim 51, wherein the web server hosts a webpage.

53. The system for rewarding of claim 52, wherein the customer interacts with the system for rewarding through the webpage.

54. The system for rewarding of claim 51, wherein the account associated with the customer is established on-line.

55. The system for rewarding of claim 51, wherein the web server acquires personal information from the customer through the Internet.

56. The system for rewarding of claim 55, wherein the computer credits the account associated with the customer with generic miles commensurately with the quality and/or quantity of personal information.

57. The system for rewarding of claim 56, wherein the computer deducts at least a portion of the generic miles credited to the account associated with the customer from the account associated with the partner.

58. The system for rewarding of claim 57, wherein the memory comprises a redemption unit defining the redemption system, the redemption unit automatically redeeming the generic miles from the one or more airlines.

59. The system for rewarding of claim 58, wherein the web server receives redemption instructions from the customer on-line, said instructions prompting the redemption unit to automatically redeem the generic miles by the customer.

60. The system for rewarding of claim 43, wherein the application server credits the accounts associated with the customer and partner.

61. The system for rewarding of claim 43, wherein the application server tracks the accounts associated with the customer and partner.

62. The system for rewarding of claim 45, wherein the application server notifies the partner when the balance of generic miles in the account associated with the partner has reached a predetermined threshold.

63. The system for rewarding of claim 43, wherein the application server notifies the customer when the balance of generic miles in the account associated with the customer has reached a redeemable level.

64. The system for rewarding of claim 43, wherein the application server verifies that a customer account has been correctly credited.

65. The system for rewarding of claim 43, wherein the application server defines the redemption system, the application server automatically redeeming the generic miles from the one or more airlines.

66. The system for rewarding of claim 51, wherein the computer establishes the account associated with a customer in response to a visit by the customer to a web page hosted by the web server.

67. The system for rewarding of claim 66, wherein the computer credits the account associated with the customer based on personal information acquired by the web server.

68. The system for rewarding of claim 67, wherein the computer credits the account commensurately with the quality and/or quality of the personal information.

69. The system for rewarding of claim 68, wherein the personal information is acquired through information from a short form generated by the web server.

70. The system for rewarding of claim 68, wherein the personal information is acquired through information from an extended form generated by the web server.

71. The system for rewarding of claim 42, wherein the computer establishes the account associated with a customer in response to a visit by the customer to a web page associated with the partner.

72. The system for rewarding of claim 42, wherein the computer credits the account associated with a customer with generic miles in response to a visit by the customer to a web page associated with the partner.

73. The system for rewarding of claim 72, wherein the computer deducts at least a portion of the generic miles credited to the account associated with the customer from the account associated with the partner.

74. The system for rewarding of claim 42, wherein the computer credits the account associated with a customer with generic miles in response to a purchase by the customer of a product or service provided by the partner.

75. The system for rewarding of claim 74, wherein the computer deducts at least a portion of the generic miles credited to the account associated with the customer from the account associated with the partner.

76. The system for rewarding of claim 74, wherein the product or service are purchased on-line.

77. The system for rewarding of claim 76, wherein the web server captures an e-mail address of the customer in response to the on-line purchase.

78. The system for rewarding of claim 77, wherein the computer determines from the captured e-mail address if an account associated with the customer has already been established, and establishes an account associated with the customer only if an account associated with the customer has not already been established.

79. The system for rewarding of claim 74, wherein the web server acquires personal information about the customer.

80. The system for rewarding of claim 79, wherein the computer credits the account of the customer with generic miles commensurately with the quality and/or quantity of the personal information.

81. The system for rewarding of claim 80, wherein the personal information is acquired through completion of an on-line short form.

82. The system for rewarding of claim 80, wherein the personal information is acquired through completion of an on-line extended form.

83. The system for rewarding of claim 77, wherein the computer generates and sends an e-mail to the captured e-mail address informing the customer that an account associated with the customer has been established and needs to be activated.

84. The system for rewarding of claim 83, wherein the computer deletes the account associated with the customer if said account is not activated.
